(19) United States
(12) Patent Application Publication
(10) Pub. No.: US 2009/0315274 A1
(43) Pub. Date: Dec. 24, 2009

(54) Gasket and pipe joint using the same

(76) Inventor: Wen-Chi Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,811

(22) Filed: Sep. 5, 2008

(30) Foreign Application Priority Data
Jun. 24, 2008 (TW) 097123521

(51) Int. Cl. F16L 17/06; F16L 59/16

(52) U.S. Cl. 277/608; 285/49

(57) ABSTRACT

The present invention discloses a gasket and a pipe joint using the same, which can achieve airtightness with a locking torque smaller than that used conventionally. The gasket of the present invention is interposed in between two coupling faces of a first pipe and a second pipe interconnecting to the first pipe, and each of the two coupling faces has at least one annular protrudent strip. The gasket of the present invention is characterized in that the gasket has at least one annular reception/contact member corresponding to the annular protrudent strip, and that the annular protrudent strip is pressed against the annular reception/contact member to form a twofold airtight mechanism with an inner annular contact area and an outer annular contact area. Thereby, the present invention can effectively promote the airtightness of the two coupling faces of the first pipe and the second pipe.

### BACKGROUND OF THE INVENTION

1. Field of the Invention

The present invention relates to a gasket interposed in between two coupled pipes and a pipe joint using the gasket which can effectively increase the airtightness of piping.

2. Description of the Related Art

In the fabrication processes of semiconductor, LCD, etc., gases, such as ammonia, nitrous oxide, nitrogen trifluoride, and fluorine, are used as the processing gases in film formation. The gas supplying apparatus that supplying these kinds of gas to the film forming processing unit has been well known to the market.

The processing gases should be of high purity lest impurities to interfere with the desired reaction. Therefore, impurities should be prevented from entering into the transporting piping from the gas container to the gas processing unit. As the processing gases are usually toxic, gas leakage should be prevented also.

Among a piping system, pipe joints interconnecting different pipes are exactly the places where gas leakage and impurity permeation are most likely to occur.

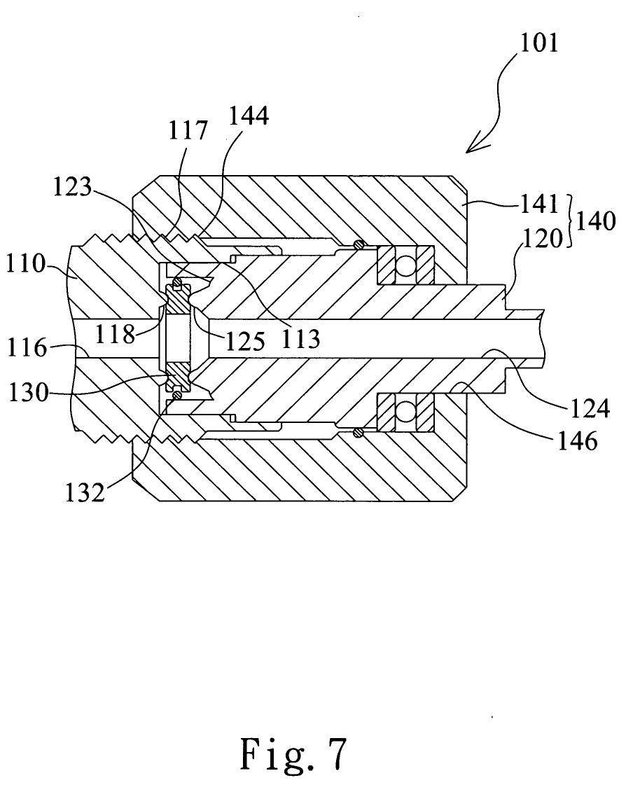

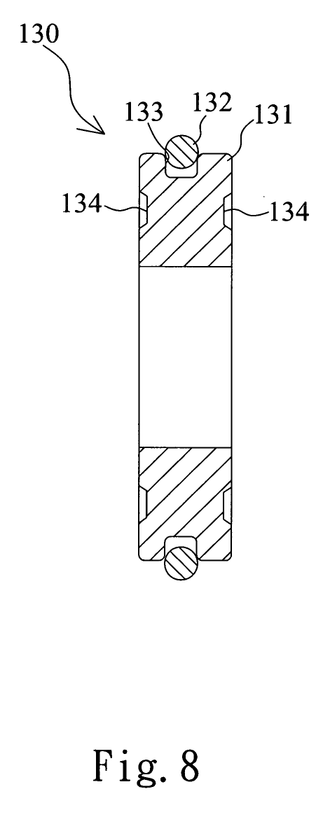

Referring to FIG. 7 and FIG. 8, these drawings schematically show the structure of a common conventional pipe joint (Referring to a Japan patent No. 2003-343762 also). As shown in FIG. 7, a pipe joint 101 has a male thread component 110 and a female thread component 140 engaging with the male thread component 110. The male thread component 110 has a male thread 117 on the external surface thereof and a fluid channel 116 along the axial direction. The base end of the fluid channel interconnects to a pipe not shown in the drawings. The male thread component 110 also has a recession 113. And a protrusion 118 projecting toward the axis direction is formed on the bottom of the recession 113.

The female thread component 140 has a body 141 and a press-fitted element 120 press-fitted into the body 141. The inner wall of the body 141 has a female thread 144 engaging with the male thread 117. The body 141 also has an axial through-hole 146. The front end of the press-fitted element 120 has a recession 123. Also a protrusion 125 is formed on the bottom of the recession 123. A gasket 130 is inlaid into the recession 123. The press-fitted element 120 also has a fluid path 124 along with the axial direction. The front end of the fluid channel 124 is at the bottom of the recession 123, and the base end of the fluid channel 124 interconnects to a pipe joined to the press-fitted element 120 (not shown in the drawing).

As shown in FIG. 8, the gasket 130 has an annular gasket body 131 and an elastic element 132 with a C-like shape arranged along the circumference of the gasket body 131. The gasket body 131 is made of high-purity nickel and has high corrosion resistance and superior airtight performance. Two sides of the annular gasket body 131 respectively have annular grooves 134. The annular gasket body 131 also has a receiving groove along the circumferential face thereof, and the elastic element 132 is arranged in the receiving groove 133. The elastic element 133 is made by elastic metal and able to expand radially.

In the pipe joint 101, the gasket 130 is interposed between the press-fitted element 120 and the male thread component 110. When the body 141 of the female thread component 140 is rotated to engage with the male thread component 110, the protrusion 118 and the protrusion 125 become close to each other and press the receiving grooves 134 of the gasket 3. Thus pressurization is attained.

In the prior-art patent, a locking torque no less than a specified value is required to guarantee airtightness. The greater the locking torque, the higher the airtightness. However, considering the convenience and efficiency of joining and disjoining pipes, it is preferable to use a smaller locking torque to achieve a higher airtightness.

Accordingly, the present invention proposes a gasket and a pipe joint using the same to overcome the above-mentioned problem.

### SUMMARY OF THE INVENTION

The primary objective of the present invention is to provide a gasket and a pipe joint using the gasket, which can achieve airtightness by a locking torque smaller than that used conventionally.

Another objective of the present invention is to provide a novel gasket, which is interposed in between two coupling faces of a first pipe and a second pipe interconnecting to the first pipe. Each of two coupling faces has at least one annular protrudent strip. The gasket of the present invention is characterized in that the gasket has at least one annular reception/contact member corresponding to the annular protrudent strip, and that the annular protrudent strip is pressed against the annular reception/contact member to form a twofold airtight mechanism with an inner annular contact area and an outer annular contact area. Even if each annular contact area of the present invention is the same as the contact area of the conventional onefold airtight mechanism or even if the locking torque used by the present invention is smaller than that used conventionally, a gap is unlikely to appear in between the coupling face and the annular reception/contact member in the present invention because of the twofold airtight mechanism of the inner and outer annular contact areas. Therefore, the present invention can effectively promote the airtightness of a pipe joint.

In the present invention, the axial pressing forces, which are generated in locking the first and second pipes, are distributed on the two annular contact areas. Thus, stress concentration is reduced, and the reception/contact members of the gasket are less likely to deteriorate or crack after long term usage. Therefore, the present invention can promote the durability of a pipe joint.

In the present invention, the annular contact areas can promote the airtightness of the two coupling face. Thus, the first and second pipes do not need a special surface finishing treatment. Therefore, the present invention can save the surface finishing process.

The annular reception/contact member of the present invention may be a V-sectioned groove having a bottom and two inclined planes converging toward the bottom.

In the present invention, the annular protrudent strip is pressed against the V-sectioned groove to form two annular contact areas on the inclined planes of the V-sectioned groove. The engagement of the annular protrudent strip and the inclined planes can prevent the annular protrudent strip from deviating from the V-sectioned groove. Therefore, the present invention can achieve a stable airtightness.

In the present invention, the annular reception/contact member may be a simple V-sectioned groove. Therefore, the gasket is easy to be fabricated.

In the present invention, recessions are respectively formed on coupling-face sides of the first pipe and the second pipe, and the gasket, whose size do not necessarily fully meet the size of the recession, can still be installed inside the recession. Therefore, the cost and steps of fabrication are decreased in the present invention. For example, the gasket has a receiving groove along the circumference thereof, and a spring is arranged inside the receiving groove. Even if the outer diameter of the gasket is smaller than the inner diameter of the recession, the spring can still keep the gasket secured inside the recession. Besides, the spring can be easily dismounted from the gasket because of its elasticity.

Further, the spring makes the gasket easily mounted in or dismounted from the recession. Therefore, the gasket of the present invention can be easily replaced.

The present invention also provides a pipe joint, which comprises a first pipe; a second pipe interconnecting to the first pipe; a gasket interposed in between the two coupling faces of the first pipe and the second pipe; and a nut used to lock together the first pipe and the second pipe both having clamped the gasket. The pipe joint is characterized in that at least one of the two coupling faces of the first pipe and the second pipe has at least one annular protrudent strip, and that the gasket has at least one annular reception/contact member corresponding to the annular protrudent strip, and that the annular protrudent strip is pressed against the annular reception/contact member to form a twofold airtight mechanism with an inner annular contact area and an outer annular contact area.

Via the above-mentioned structure, the pipe joint of the present invention has superior airtightness.

In the present invention, the annular protrudent strip has a semi-circle cross-section; the annular reception/contact member is a V-sectioned groove having an arc-sectioned bottom and two inclined planes converging toward the arc-sectioned bottom; the two inclined planes respectively extend from the tangents of two ends of the arc-sectioned bottom; the annular protrudent strip has a curvature radius greater than that of the arc-sectioned bottom.

Via the above-mentioned structure, the top of the annular protrudent -strip contacts the two inclined planes of the V-sectioned groove. As the curvature radius of the annular protrudent strip is greater than that of the arc-sectioned bottom of the V-sectioned groove, the top of the annular protrudent strip does not contact the arc-sectioned bottom, thus a gap exists between the top of the annular protrudent strip and the arc-sectioned bottom, which guarantees the formation of the twofold airtight mechanism of the inner and outer annular contact areas. Thereby, the pipe joint of the present invention has superior airtightness.

Below, the embodiments are described in detail to make it more easily understandable of the objectives, technical contents, characteristics and efficacies of the present invention.

### BRIEF DESCRIPTION OF THE RELATED ART

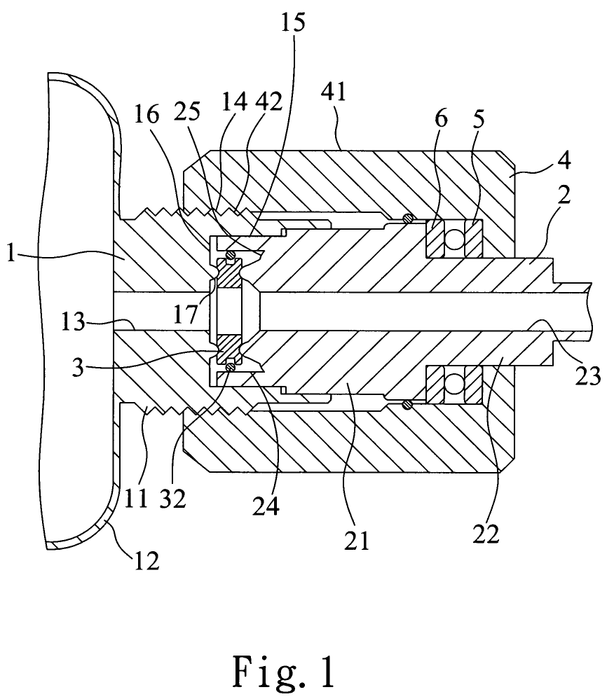

FIG. 1 is an axial cross-sectional view of a gasket and a pipe joint using the gasket according to one embodiment of the present invention;

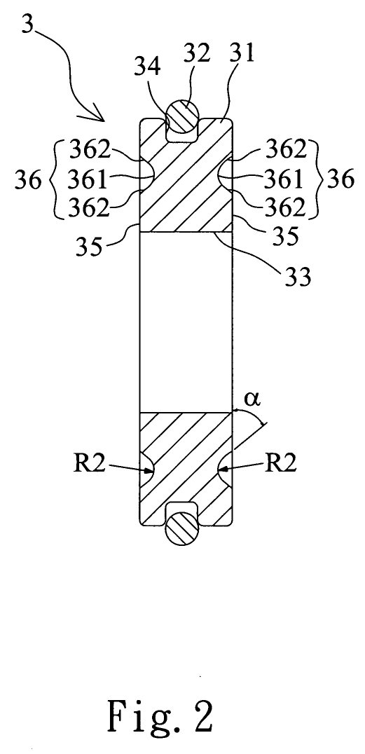

FIG. 2 is an axial cross-sectional view of the gasket according to the same embodiment of FIG. 1;

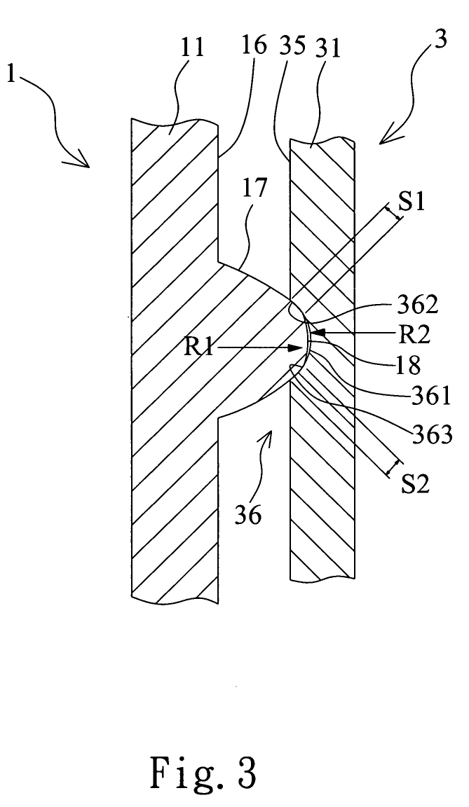

FIG. 3 is a partially enlarged cross-sectional view of the gasket and the first pipe according to the same embodiment of FIG. 1;

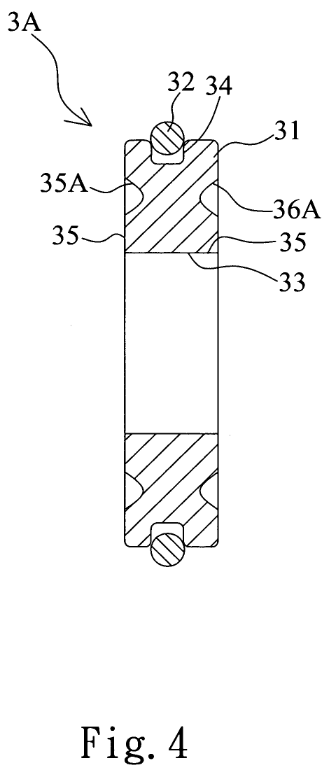

FIG. 4 is an axial cross-sectional view of a gasket according to another embodiment of the present invention;

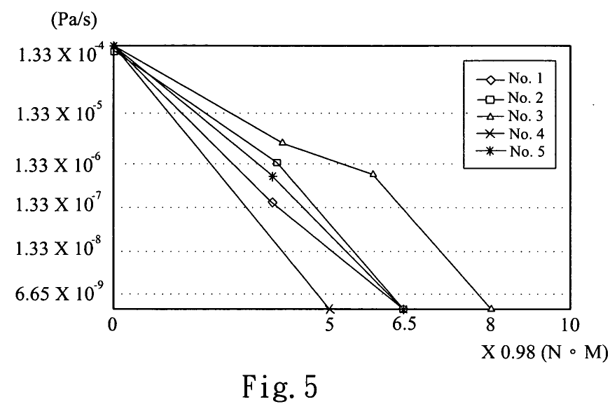

FIG. 5 is a diagram showing the test results of the pipe joint using the present invention;

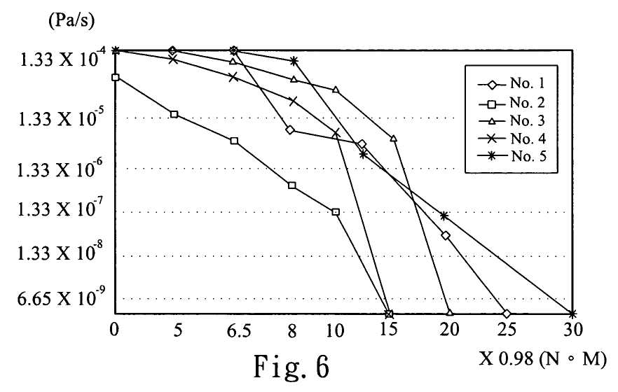

FIG. 6 is a diagram showing the test results of the pipe joint using the conventional technology;

FIG. 7 is an axial cross-sectional view of a conventional gasket and a conventional pipe joint; and

FIG. 8 is an axial cross-sectional view of the same conventional gasket in FIG. 7.

### DETAILED DESCRIPTION OF THE INVENTION

Refer to FIG. 1 an axial cross-sectional view of a gasket and a pipe joint using the same according to one embodiment of the present invention.

In this embodiment, the pipe joint comprises a first pipe 1, a second pipe 2 interconnecting to the first pipe 1, a gasket 3 interposed in between a first coupling face 16 of the first pipe 1 and a second coupling face 25 of the second pipe 2, a cap-shaped nut 4 used to lock together the first pipe 1 and the second pipe 2 with the gasket 3 clamped by the first pipe 1 and the second pipe 2, and a bearing 5 arranged in between the second pipe 2 and the cap-shaped nut 4.

The first pipe 1 is made of a stainless steel and comprises a cylindrical pipe body 11 having a diameter of about 20˜30 mm, a container 12 joined to the base end of the pipe body 11, and a first channel 13 axially formed inside the pipe body 11 and allowing a fluid to flow there inside.

A male thread 14 is formed on the external surface of the pipe body 11. A first recession 15 is formed on the front end of the pipe body 11. The bottom of the first recession 15 is used as the first coupling face 16. The front end of the first channel 13 has an opening at the center of the first coupling face 16. The base end of the first channel 13 interconnects to the interior of the container 12. The first coupling face 16 has a first annular protrudent strip 17 encircling the first channel 13 and having a semi-circle cross-section.

The second pipe is made of a stainless steel and comprises a cylindrical pipe body 21, a pipe piece 22 axially extending from the base end of the pipe body 21, and a second channel 23 axially formed inside the pipe body 21 and the pipe piece 22 and allowing a fluid to flow there inside.

A second recession 24 is formed on the front end of the pipe body 21 and corresponding to the first coupling face 16. The gasket 3 is to be inlaid in the second recession 24. The bottom of the second recession 24 is used as the second coupling face 25. The front end of the second channel 23 has an opening at the center of the second coupling face 25. The base end of the second channel 23 interconnects to a pipe (not shown in the drawing) joined to the base end of the pipe piece 22.

The second coupling face 25 has a second annular protrudent strip 26 encircling the second channel 23 and having a semi-circle cross-section. The second annular protrudent strip 26 is corresponding to the first annular protrudent strip 17 with the gasket 3 interposed there in between.

Refer to FIG. 2 an axial cross-sectional view of the gasket 3.

The gasket 3 comprises a gasket body 31, a spring 32 arranged along the circumference of the gasket body 31, and a gasket hole 33 formed at the center of the gasket body 31.

The gasket body 31 is made of a highly corrosion-resistant high-purity nickel. The circumference of the gasket body 31 has a receiving groove 34 to accommodate the spring 32. The gasket body 21 may also be made of a stainless steel. Sometimes, a highly corrosion-resistant metal used by a gasket, such as nickel or stainless steel, is too hard to have a full airtightness. Therefore, the nickel or stainless steel used by the gasket 3 had better be annealed to have hardness lower than that of the first and second pipes 1 and 2.

The gasket body 31 has two side faces 35 respectively corresponding to the first coupling face 16 of the first pipe 1 and the second coupling face 25 of the second pipe 2.

Each of the side faces 35 has an annular V-sectioned groove 36 encircling the gasket hole 33 and is functioning as an annular reception/contact member. The annular V-sectioned groove 36 has an unsharpened arc-sectioned bottom 361 and two inclined planes 362 converging toward the arc-sectioned bottom 361. The annular V-sectioned groove 36 has a V-shaped section. In this embodiment, the tangent of each inclined plane 362 has a tilt angle of about 40 degrees with respect to the side face 35 (the angle denoted by α in FIG. 2). The two annular V-sectioned grooves 36 are respectively formed on the positions corresponding to the first protrudent strip 17 and the second protrudent strip 26. In the present invention, the tilt angle α is between 20 and 70 degrees.

The spring 32 is a stainless-steel wire bent into a C shape. The spring 32 is arranged in the receiving groove 34 and can deform and recover from deformation in the circumferential direction.

The cap-shaped nut 4 is made of a stainless steel. The cap-shaped nut 4 is a hexagonal-prism component having a hexagonal cross-section in the direction vertical to the axis. The cap-shaped nut 4 has rectangular side faces 41 and a female thread 42 on the inner wall at the front end of the cap-shaped nut 4 (near the container 12).

The bearing 5 inside the cap-shaped nut 4 receives the second pipe 2, and the cap-shaped nut 4 can rotate freely with respect to the second pipe 2. Via screwing the female thread 42 into the male thread 14 of the first pipe 1, the first pipe 1 and the second pipe 2 is locked together, and the gasket 3 is also clamped by the first annular protrudent strip 17 and the second annular protrudent strip 26.

A positioning element 6 is secured in the inner wall of the cap-shaped nut 4 and arranged in between the bearing 5 and the outer surface of the pipe body 21 lest the bearing 5 drops out from the inner wall of the cap-shaped nut 4.

Refer to FIG. 3 a partially enlarged cross-sectional view of the gasket 3 and the first pipe 1.

The two inclined planes 362 of the annular V-sectioned groove 36 are pressed against two sides of the top 18 of the first protrudent strip 17 to form two annular contact areas S1 and S2 on the two inclined planes 362. The annular contact areas S1 and S2 encircle the gasket hole 33 and form a twofold airtight mechanism with an inner annular contact area and an outer annular contact area.

As the inclined planes 362 are pressed against the top 18 of the first protrudent strip 17, the two annular contact areas S1 and S2 are elastically deformed and flattened, whereby the contact area in between the first protrudent strip 17 and the V-sectioned groove 36 is increased. Besides, the opening of the V-sectioned groove 36 is also elastically expanded to have a tilt angle greater than before pressing, whereby the contact area in between the first protrudent strip 17 and the V-sectioned groove 36 is further increased. Therefore, the airtightness is increased.

As the curvature radius R1 of the first protrudent strip 17 is greater than the curvature radius R2 of the arc-sectioned bottom 361 of the V-sectioned groove 36, a gap exists in between the top 18 of the first protrudent strip 17 and the arc-sectioned bottom 361 of the V-sectioned groove 36, which guarantees the formation of the twofold airtight mechanism of the annular contact areas S1 and S2.

The airtight mechanism in between the gaskets and the second pipe 2 is similar to that in between the gasket 3 and the first pipe 1.

Below is described the method of locking together the first pipe 1 and the second pipe 2 with the cap-shaped nut 4.

Firstly, the spring 32 is greatly expanded and then inlaid into the receiving groove 34. Next, the gasket 3 is inlaid in the second recession 24 of the second pipe 2. At this time, the V-sectioned groove 36 on the side face 35 facing the second pipe 2 is pressed against the second protrudent strip 25. Next, the second pipe 2 is accommodated inside the cap-shaped nut 4.

Next, the second pipe 2 is inserted into the first recession 15 of the first pipe 1 to press the V-sectioned groove 36 of the side face 35 facing the first pipe 1 against the first protrudent strip 17 of the first pipe 1. Next, the female thread 42 of the cap-shaped nut 4 is screwed into the male thread 14 of the first pipe 1. A wrench is used to clamp the rectangular side faces 41 of the cap-shaped nut 4, and a locking torque of a specified value is applied to the wrench to lock the cap-shaped nut 4. As the bearing 5 exists in between the second pipe 2 and the cap-shaped nut 4, only the cap-shaped nut 4 rotates, and the second pipe 2 remains standstill. Therefore, the first pipe 1, the second pipe 2 and the reception/contact members of the gasket 3 will not wear.

During screwing the cap-shaped nut 4, an axial pressing force from base end to the front end of the first pipe 1 acts on the first coupling face 16 of the first pipe 1, and an axial pressing force from the base end to the front end of the second pipe 2 acts on the second coupling face 25 of the second pipe 2. Thus, the first coupling face 16 and the second coupling face 25 are forcefully pressed to each other with the gasket 3 clamped by them. As shown in FIG. 3, the top 18 of the first protrudent strip 17 is pressed against the two inclined planes 362 of the V-sectioned groove 36, and the two annular contact areas S1 and S2 are thus formed on the two inclined planes 362.

After the cap-shaped nut 4 has been locked by the locking torque of a specified value, the annular contact areas S1 and S2 have a width of 0.1˜0.4 mm. The width of the annular contact areas S1 and S2 had better be adjusted according to the size of the pipe joint or the flow rate of the fluid.

Thereby it is completed the locking of the first pipe 1 and the second pipe 2. The first channel 13 and the second channel 23 are thus airtightly interconnected.

Via the structure described above, this embodiment of the present invention has the following efficacies:
(1) As two sets of annular contact areas S1 and S2 respectively exist in between the two inclined planes 362 and the first protrudent strip 17 and in between the other two inclined planes 362 and the second protrudent strip 26, gaps are less unlikely to appear in between the first pipe 1 and the second pipe 2 of the present invention than in the conventional pipe joint having only a single contact area. Thus, the present invention can promote the airtightness of a pipe joint. Even when the locking torque is smaller, the present invention can still guarantee the airtightness.
(2) As the axial pressing forces are distributed on the two annular contact areas S1 and S2, stress concentration is reduced. Unlike the conventional gasket and pipe joint having only a single contact area, the reception/contact members of the gasket 3 and the first and second pipes 1 and 2 are less likely to deteriorate or crack after long term usage. Therefore, the present invention can promote the durability of a pipe joint.
(3) Since the annular contact areas S1 and S2 formed on the V-sectioned groove 36 can promote the airtightness of the first coupling face 16 and the second coupling face 25, the first pipe 1 and the second pipe 2 do not need a special surface finishing treatment. Therefore, the present invention can save the surface finishing process.
(4) The engagement of the first protrudent strip 17, the second protrudent strip 26 and the inclined planes 362 of the V-sectioned grooves 36 can prevent the first protrudent strip 17 and the second protrudent strip 26 from deviating from the V-sectioned grooves 36. Therefore, the present invention can achieve a stable airtightness.
(5) As the V-sectioned grooves 36 have a simple shape, they are easy to fabricate.
(6) As the gasket 3 does not need a high a precision to meet the size of the second recession 24, the cost and steps of fabrication are decreased. In other words, even when the outer diameter of the gasket 3 is smaller than the inner diameter of the second recession 24, the spring 32 can still keep the gasket 3 secured inside the second recession 24. Because of the elasticity of the spring 32, the gasket 3 is easy to mount into or dismount from the second recession 24. Therefore, the gasket 3 can be replaced easily.
(7) As the curvature radius R1 of the first protrudent strip 17 is greater than the curvature radius R2 of the arc-sectioned bottom 361, a gap exists in between the top 18 of the first protrudent strip 17 and the arc-sectioned bottom 361, which guarantees the formation of the two annular contact areas S1 and S2 and the airtightness of the pipe joint.
(8) As the gasket 3 is made of a metallic material, it is unlikely to swell by imbibing water or another liquid or by heat. Therefore, the present invention can keep the airtightness of the first coupling face 16 and the second coupling face 25 for a long time.
(9) As the spring 32 having a C-like shape that can deform and recover from deformation in the circumferential direction, it is easy to be expanded and received by the receiving groove 34. Because of the elasticity of the spring 32, the gasket 3 is easy to mount into or dismount from the second recession 24. Therefore, the present invention can convenience the replacement of the gasket 3.

The present invention is not limited by the embodiments described above but also includes any modification and variation able to achieve the objectives of the present invention.

In the above-mentioned embodiments, the first protrudent strip 17 of the first coupling face 16 and the second protrudent strip 26 of the second coupling face 25 have a semi-circle section. However, the protrudent strips of the present invention are not limited to having a semi-circle section. Any convex element protruding from the first coupling face 16 and the second coupling face 25 may also function as the protrudent strip and are also included by the present invention. For example, the protrudent strip may also be a dual-ridged element.

In the above-mentioned embodiments, the V-sectioned grooves 36 are used as the annular reception/contact members. However, the annular reception/contact members of present invention are not limited to having a V-shaped section. Any groove, which is able to form twofold annular contact areas with the first protrudent strip 17 of the first coupling face 16 and the second protrudent strip 26 of the second coupling face 25, may also function as the annular reception/contact member and is also included by the present invention, such as the grooves shown in FIG. 4.

Refer to FIG. 4. U-sectioned grooves 36A having a semi-oval section are respectively formed on two side faces 35 of a gasket 3A and function as the annular reception/contact members of the present invention. The tops of two sides of the U-sectioned groove 36A has a width greater than that of the tops of the first protrudent strip 17 and second protrudent strip 26, but the bottom of the U-sectioned groove 36A has a curvature radius smaller than that of the tops of the first protrudent strip 17 and second protrudent strip 26. Therefore, the tops of the first protrudent strip 17 and second protrudent strip 26 contact the two sides of the U-sectioned grooves 36A. Thus is formed an inner annular contact area and an outer annular contact area on the U-sectioned groove 36A. Thereby, superior airtightness is achieved.

The present invention also includes an embodiment that only one side face 35 of the gasket body 31 has the annular reception/contact member, and the opposite side face 35 has none annular reception/contact member. The present invention also includes an embodiment that both side faces 35 have different types of annular reception/contact members. For example, one side face 35 has the V-sectioned groove 36 shown in FIG. 2, and the opposite side face 35 has the U-sectioned groove 36A shown in FIG. 4.

Below are shown the tests for comparing the present invention with the conventional technology.

The leakage tests are undertaken for the gasket and pipe joint described in the above-mentioned embodiments and the conventional gasket and pipe joint:
1. Test item
   Finding the locking torque guaranteeing that none leakage occurs
2. Test conditions
   Including number of samples, locking torque, test gas, and lower limit of leakage
   (1) number of samples: 5
   (2) test gas: helium
   (3) locking torque: 5, 6.5, 8, 10, 15, 20, 25, 30 N·m
   (4) lower limit of leakage: 6.55×10⁻⁹ Pa/s (5×10⁻¹¹ torr/s)
3. Test method
   (1) Close the pipe on one side of the pipe joint, and switching on a valve to interconnect the pipe on the other side to a vacuum pump
   (2) Evacuate the interior of the pipe joint, switching off the valve and dismounting the vacuum pump
   (3) Place the pipe joint in a container filled with helium for a specified period of time
   (4) Take out the pipe joint, and use a leakage test apparatus to test leakage
   (5) Vary the locking torque, and repeat the steps of from (1) to (4)
4. Results and analysis

FIG. 5 shows the test results of the pipe joint using the present invention, and FIG. 6 shows the test results of the pipe joint using the conventional technology (shown in FIG. 7 and FIG. 8), wherein the vertical axis denotes the leakage rate (Pa/s) and the horizontal axis denotes the locking torque (N·m).

In the test for the present invention, when the locking torque is 5 N·m, the leakage rate of only one sample is below the lower limit. When the locking torque is 6.5 N·m, the leakage rates of four samples are below the lower limit. When the locking torque is 8 N·m, the leakage rates of all samples are below the lower limit.

In the test for the conventional technology, not all the samples are below the lower limit until the locking torque reaches as high as 30 N·m. Thus, the present invention can achieve the same airtightness with only a locking torque of no less than 8 N·m.

In other words, the present invention can use a smaller locking torque than the conventional technology to achieve identical airtightness; and the present invention can use identical locking torque to achieve higher airtightness than the conventional technology.

Furthermore, the present invention not only can lock together two pipes airtightly but also can couple together two workpieces seamlessly.

The embodiments described above are only to exemplify the present invention but not to limit the scope of the present invention. Therefore, any modification or variation according to the characteristics or spirit of the present invention is to be also included within the scope of the present invention.

What is claimed is:

1. A gasket, interposed in between two coupling faces of a first pipe and a second pipe interconnecting to said first pipe with each of said two coupling faces having at least one annular protrudent strip, and characterized in said gasket has at least one annular reception/contact member corresponding to said annular protrudent strip, and said annular protrudent strip is pressed against said annular reception/contact member to form a twofold airtight mechanism with an inner annular contact area and an outer annular contact area.

2. The gasket according to claim 1, wherein said annular reception/contact member is an annular V-sectioned groove having an arc-sectioned bottom and two inclined planes converging toward said arc-sectioned bottom.

3. The gasket according to claim 2, wherein said two inclined planes extending from tangents of two ends of said arc-sectioned bottom.

4. The gasket according to claim 3, wherein said annular protrudent strip has a curvature radius greater that that of said arc-sectioned bottom.

5. The gasket according to claim 1, wherein said gasket has an annular receiving groove along a circumference of said gasket, and said annular receiving groove accommodates an annular spring.

6. The gasket according to claim 1, wherein said annular protrudent strip has a semi-circle section.

7. The gasket according to claim 1, wherein said gasket is made of a highly corrosion-resistant material.

8. The gasket according to claim 7, wherein said gasket is made of nickel or a stainless steel.

9. A pipe joint,
comprising
a first pipe;
a second pipe interconnecting to said first pipe, wherein each of two coupling faces of said first pipe and said second pipe has at least one annular protrudent strip;
a gasket interposed in between said two coupling faces of said first pipe and said second pipe; and
a nut used to lock together said first pipe and said second pipe both having clamped said gasket,
and characterized in
that said gasket has at least one annular reception/contact member corresponding to said annular protrudent strip, and
that said annular protrudent strip is pressed against said annular reception/contact member to form a twofold airtight mechanism with an inner annular contact area and an outer annular contact area.

10. The pipe joint according to claim 9, wherein said annular protrudent strip has a semi-circle section.

11. The pipe joint according to claim 9, wherein said annular reception/contact member is an annular V-sectioned groove having an arc-sectioned bottom and two inclined planes converging toward said arc-sectioned bottom.

12. The pipe joint according to claim 11, wherein said two inclined planes respectively extend from tangents of two ends of said arc-sectioned bottom.

13. The pipe joint according to claim 11, wherein said annular protrudent strip has a curvature radius greater that that of said arc-sectioned bottom.

14. The pipe joint according to claim 9, wherein said gasket has an annular receiving groove along a circumference of said gasket, and said annular receiving groove accommodates an annular spring.

15. The pipe joint according to claim 9, wherein said gasket is made of a highly corrosion-resistant material.

16. The pipe joint according to claim 15, wherein said gasket is made of nickel or a stainless steel.
